(19) United States
(12) Patent Application Publication
(10) Pub. No.: US 2012/0138021 A1
(43) Pub. Date: Jun. 7, 2012

(54) SOLENOID VALVE CONTROL METHOD AND HIGH PRESSURE FUEL PUMP OF GDI ENGINE

(75) Inventors: Deok Ryol Kim, Yongin-city (KR); Byoungsoo Lim, Seoul (KR)

(73) Assignee: Hyundai Motor Company, Seoul (KR)

(21) Appl. No.: 13/210,076

(22) Filed: Aug. 15, 2011

(30) Foreign Application Priority Data
Dec. 7, 2010 (KR) 10-2010-0124167

(51) Int. Cl. F02D 41/30; F16K 31/02

(52) U.S. Cl. 123/495; 251/129.15

(57) ABSTRACT

A solenoid valve control method for a high pressure fuel pump of GDI engine includes supplying peak current for closing a solenoid valve during a predetermined peak current supply period and supplying hold current for holding the solenoid valve during a predetermined hold current supply period after the predetermined peak current supply period. The solenoid valve control method for a high pressure fuel pump of GDI engine may reduce impact of closing/opening of a solenoid valve.

### CROSS-REFERENCE TO RELATED APPLICATION

This application claims priority to and the benefit of Korean Patent Application No. 10-2010-0124167 filed Dec. 7, 2010, the entire contents of which application is incorporated herein for all purposes by this reference.

### BACKGROUND OF INVENTION

1. Field of Invention

The present invention relates to a control method of a solenoid valve. More particularly, the present invention relates to a control method for a high pressure fuel pump of GDI engine and a high pressure fluid pump.

2. Description of Related Art

Since a GDI (gasoline direct injection) engine supplies fuel directly to a combustion chamber different from a MPI (multi position injection), and thus particles of fuel must be downsized.

For downsizing the fuel particles, fuel pressure must be increased to about 40-150 bars. (in MPI engine, fuel pressure is about 3-4 bar) And thus for realizing high pressure, a high pressure pump driven by a camshaft is required.

FIG. 1 is a cross-sectional view of a high pressure fuel pump for a GDI engine and FIG. 2 is an enlarged cross-sectional view of A of FIG. 1.

Referring to FIG. 1 and FIG. 2, in a high pressure fuel pump 10 for a GDI engine, a high pressure pump piston 20 reciprocates according to rotation of a camshaft and generates high pressure in a hydraulic pressure chamber 30.

An ECU controls to supply power to a solenoid valve 40 to control hydraulic pressure in the hydraulic pressure chamber 30 and thus high pressured fuel is injected through an injector.

The solenoid valve 40, referring to FIG. 2, includes a pole piece 42, an adjuster 44, a spring 46 and an anchor 48, and a plate 50, a pod 52, a valve disk 54 and a valve blade 56 are provided to the fuel pump 10 and the high pressured fuel is injected through the injector.

FIG. 5 is a graph showing control signal of a conventional solenoid valve of a high pressure fuel pump for a GDI engine.

Referring to FIG. 5, when the solenoid valve 40 receives electric power, a spill valve (the valve disk 54 and the valve blade 56) is closed, but after the valve is closed, still current is applied so that impact may be occurred (referring to B of FIG. 2)

That is, a peak time period is too long so that impact between the anchor 48 and the pole piece 42 is considerable.

Contrary, when the applied current to the solenoid valve 40 is cut off, the spill valve is opened. And when the valve is opened, the anchor 48 moves backward and impact occurs in area C of FIG. 2. That is, when the valve is opened, current control does not exist.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a control method for a high pressure fuel pump of GDI engine and a high pressure fluid pump having advantages of reducing impact according to supplying and cutting off power to a solenoid valve.

A solenoid valve control method for a high pressure fuel pump of GDI engine according to various aspects of the present invention may include supplying peak current for closing a solenoid valve during a predetermined peak current supply period and supplying hold current for holding the solenoid valve during a predetermined hold current supply period after the predetermined peak current supply period.

The predetermined peak current supply period may be shorter than a period of complete closing of the solenoid valve.

The solenoid valve control method may further include supplying reducing speed current after the supplying hold current.

The supplying reducing speed current may be implemented after the supplying the hold current and a predetermined reducing speed current supply delay period.

The supplying the reducing speed current may be completed before the solenoid valve is completely opened.

Current value of the reducing speed current may be less than current value of the peak current.

A solenoid valve control method for a high pressure fuel pump of GDI engine according to various aspects of the present invention may include supplying peak current for closing a solenoid valve during a predetermined peak current supply period, supplying hold current for holding the solenoid valve during a predetermined hold current supply period after the predetermined peak current supply period and supplying reducing speed current after the supplying hold current.

The supplying reducing speed current may be implemented after the supplying the hold current and a predetermined reducing speed current supply delay period.

The supplying the reducing speed current may be completed before the solenoid valve is completely opened.

Current value of the reducing speed current may be less than current value of the peak current. The supplying peak current may be completed before the solenoid valve is completely closed.

A solenoid valve control method for a high pressure fluid pump according to various aspects of the present invention may include supplying peak current for closing a solenoid valve during a predetermined peak current supply period and supplying hold current for holding the solenoid valve during a predetermined hold current supply period after the predetermined peak current supply period.

The predetermined peak current supply period may be shorter than a period of complete closing of the solenoid valve.

The solenoid valve control method may further include supplying reducing speed current after the supplying hold current.

The supplying reducing speed current may be implemented after the supplying the hold current and a predetermined reducing speed current supply delay period.

The supplying the reducing speed current may be completed before the solenoid valve is completely opened.

Current value of the reducing speed current may be less than current value of the peak current.

A solenoid valve control method for a high pressure fluid pump according to various aspects of the present invention may include supplying peak current for closing a solenoid valve during a predetermined peak current supply period, supplying hold current for holding the solenoid valve during a predetermined hold current supply period after the predetermined peak current supply period and supplying reducing speed current after the supplying hold current.

The supplying reducing speed current may be implemented after the supplying the hold current and a predetermined reducing speed current supply delay period.

The supplying the reducing speed current may be completed before the solenoid valve is completely opened.

Current value of the reducing speed current may be less than current value of the peak current. The supplying peak current may be completed before the solenoid valve is completely closed.

According to various aspects of a control method for a high pressure fuel pump of GDI engine of the present invention, impact according to supplying and cutting off power to a solenoid valve may be reduced.

Also, the same control method may be applied to control method for an injector or purge control solenoid valve which may be supplied current to operate.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of a high pressure fuel pump for a GDI engine.

FIG. 2 is an enlarged cross-sectional view of A of FIG. 1.

FIG. 3 is a graph showing control signal of an exemplary solenoid valve of a high pressure fuel pump for a GDI engine according to the present invention.

FIG. 4 is a flowchart of an exemplary control method for a solenoid valve of a high pressure fuel pump for a GDI engine according to the present invention.

FIG. 5 is a graph showing control signal of a conventional solenoid valve of a high pressure fuel pump for a GDI engine.

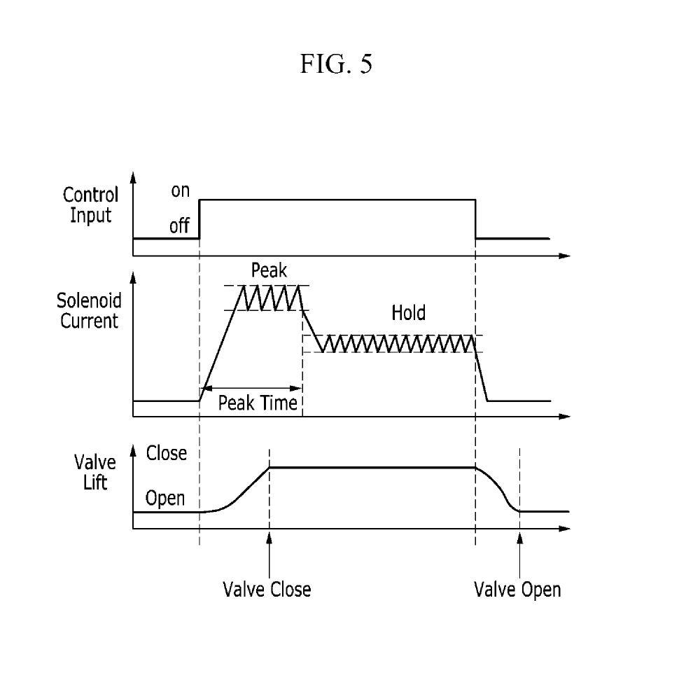

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

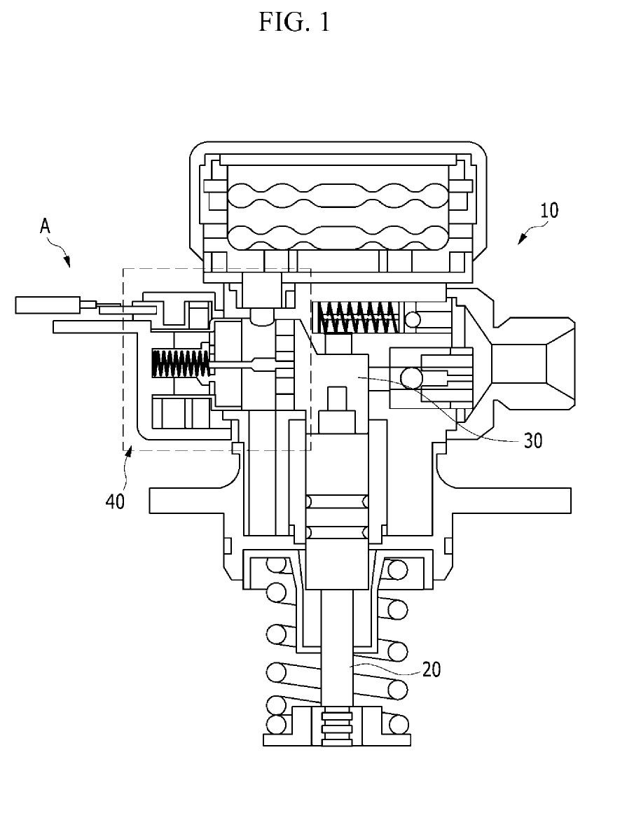

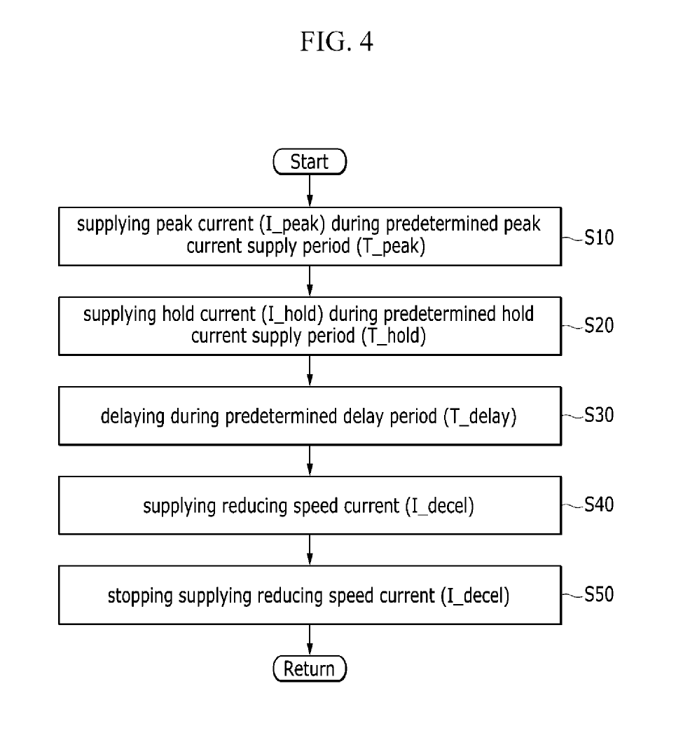

Referring to FIG. 1 to FIG. 4, a control method for a solenoid valve of a high pressure fuel pump for a GDI engine according to various embodiments of the present invention includes supplying peak current I_peak for closing a solenoid valve 40 (ON) during a predetermined peak current supply period T_peak and (S10) and supplying hold current I_hold for holding the solenoid valve 40 during a predetermined hold current supply period T_hold after the predetermined peak current supply period T_peak (S20).

The peak current supply period T_peak is shorter than a period of complete closing of the solenoid valve 40.

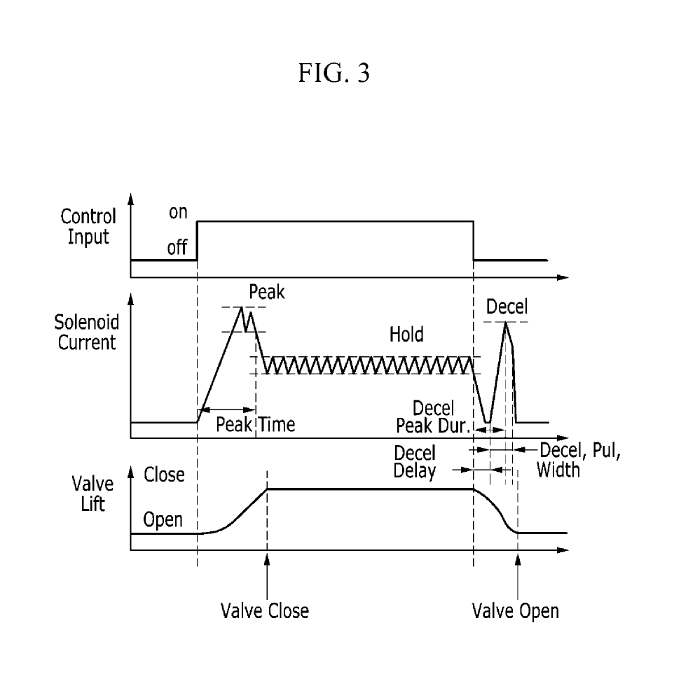

That is, as shown in FIG. 3, the peak current I_peak is supplied during the peak current supply period T_peak which is shorter than the period of complete closing of the solenoid valve 40 and the hold current I_hold for holding the solenoid valve 40 to be maintain in closed state is supplied before the solenoid valve 40 is completely closed so as to reduce impact between the anchor 48 and the pole piece 42 as described in the description of the related art. And thus, soft landing may be achieved.

While a general peak current supply period may be about 2500 μs, however the peak current supply period T_peak according to various embodiments of the present invention may be about 1000 μs and thus impact may be reduced.

However, the peak current supply period T_peak may be determined by experiments considering capacities of the high pressure fuel pump 10 for the GDI engine, pressure variation and so on.

The control method for a solenoid valve of a high pressure fuel pump for a GDI engine according to various embodiments of the present invention further includes supplying reducing speed current I_decel (S40) after the supplying hold current I_hold.

The supplying the reducing speed current I_decel (S40) is implemented after the supplying the hold current I_hold (S20) and a predetermined reducing speed current supply delay period T_delay (S30).

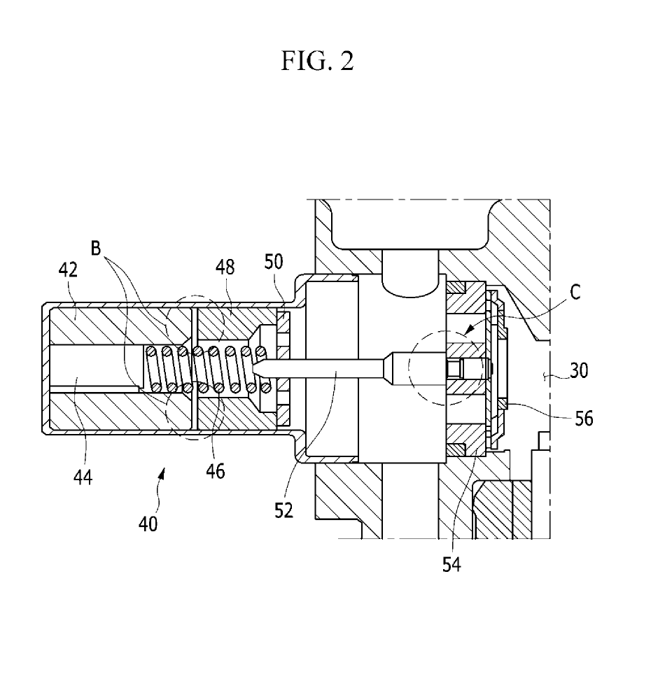

That is, as shown in FIG. 3, after supplying the hold current I_hold for maintaining opened state of the solenoid valve 40, current supply is suspended during a predetermined period, that is the reducing speed current supply delay period T_delay so as to open the solenoid valve 40 (OFF). And then the reducing speed current I_decel is supplied during opening of the solenoid valve 40 so as to reduce impact at “C” of FIG. 2.

Step S40 of the reducing speed current I_decel may stop before complete opening of the solenoid valve 40 and current value of the reducing speed current I_decel is less than current value of the peak current I_peak.

That is, if the reducing speed current I_decel is excessively supplied, the solenoid valve 40 may be disrupted to completely opened, and thus the current value of the reducing speed current I_decel is less that the current value of the peak current I_peak and supplying the reducing speed current I_decel is stopped before the solenoid valve 40 is completely opened (Decel, Pul, Width).

The control method for a solenoid valve of a high pressure fuel pump for a GDI engine according to various embodiments of the present invention may be applied to embody an injector or purge control solenoid valve which may be supplied current to operate. The operation fundamentals and effects are identical so that repeated explanation will be omitted.

According to various embodiments of the present invention, impacts according to supply/cut off current for operate the solenoid valve may be reduced and thus the solenoid valve of a high pressure fuel pump for a GDI engine or the solenoid valve for a high pressure fluid pump may realize noise reduction and durability enhancement.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A solenoid valve control method for a high pressure fuel pump of GDI engine comprising:
supplying peak current for closing a solenoid valve during a predetermined peak current supply period; and
supplying hold current for holding the solenoid valve during a predetermined hold current supply period after the predetermined peak current supply period.

2. The solenoid valve control method of claim 1, wherein the predetermined peak current supply period is shorter than a period of complete closing of the solenoid valve.

3. The solenoid valve control method of claim 2, wherein the solenoid valve control method further comprises:
supplying reducing speed current after the supplying hold current.

4. The solenoid valve control method of claim 3, wherein the supplying reducing speed current is implemented after the supplying the hold current and a predetermined reducing speed current supply delay period.

5. The solenoid valve control method of claim 4, wherein the supplying the reducing speed current is completed before the solenoid valve is completely opened.

6. The solenoid valve control method of claim 3, wherein current value of the reducing speed current is less than current value of the peak current.

7. The solenoid valve control method of claim 3, wherein the supplying peak current is completed before the solenoid valve is completely closed.

8. A solenoid valve control method for a high pressure fluid pump comprising:
supplying peak current for closing a solenoid valve during a predetermined peak current supply period; and
supplying hold current for holding the solenoid valve during a predetermined hold current supply period after the predetermined peak current supply period.

9. The solenoid valve control method of claim 8, wherein the predetermined peak current supply period is shorter than a period of complete closing of the solenoid valve.

10. The solenoid valve control method of claim 9, wherein the solenoid valve control method further comprises:
supplying reducing speed current after the supplying hold current.

11. The solenoid valve control method of claim 10, wherein the supplying reducing speed current is implemented after the supplying the hold current and a predetermined reducing speed current supply delay period.

12. The solenoid valve control method of claim 11, wherein the supplying the reducing speed current is completed before the solenoid valve is completely opened.

13. The solenoid valve control method of claim 10, wherein current value of the reducing speed current is less than current value of the peak current.

14. A solenoid valve control method for a high pressure fluid pump comprising:
supplying peak current for closing a solenoid valve during a predetermined peak current supply period;
supplying hold current for holding the solenoid valve during a predetermined hold current supply period after the predetermined peak current supply period; and
supplying reducing speed current after the supplying hold current.

15. The solenoid valve control method of claim 14, wherein the supplying reducing speed current is implemented after the supplying the hold current and a predetermined reducing speed current supply delay period.

16. The solenoid valve control method of claim 15, wherein the supplying the reducing speed current is completed before the solenoid valve is completely opened.

17. The solenoid valve control method of claim 15, wherein current value of the reducing speed current is less than current value of the peak current.

18. The solenoid valve control method of claim 14, wherein the supplying peak current is completed before the solenoid valve is completely closed.

19. The solenoid valve control method of claim 14, wherein the high pressure fluid pump is a high pressure fuel pump of a GDI engine.

20. The solenoid valve control method of claim 8, wherein the high pressure fluid pump is a high pressure fuel pump of a GDI engine.
